(19) United States
(12) Patent Application Publication
(10) Pub. No.: US 2004/0222987 A1
(43) Pub. Date: Nov. 11, 2004

(54) Multiframe image processing

(76) Inventors: Nelson Liang An Chang, Palo Alto, CA (US); I-Jong Lin, Tokyo (JP)

Correspondence Address: HEWLETT-PACKARD COMPANY, Intellectual Property Administration, P.O. Box 272400, Fort Collins, CO, 80527-2400, US

(21) Appl. No.: 10/434,351

(22) Filed: May 8, 2003

(51) Int. Cl. G06T 15/00

(52) U.S. Cl. 345/419

(57) ABSTRACT

Systems and methods of multiframe image processing are described. In one aspect, correspondence mappings from one or more anchor views of a scene to a common reference anchor view are computed, and anchor views are interpolated based on the computed correspondence mappings to generate a synthetic view of the scene.

### CROSS-REFERENCE TO RELATED APPLICATIONS

This application relates to U.S. patent application Ser. No. ______, filed Feb. 3, 2003, by Nelson Liang An Chang et al. and entitled “Multiframe Correspondence Estimation” [Attorney Docket No. 100202234-11, which is incorporated herein by reference.

### TECHNICAL FIELD

This invention relates to systems and methods of multiframe image processing.

### BACKGROUND

Interactive 3-D (three-dimensional) media is becoming increasingly important as a means of communication and visualization. Photorealistic content like “rotatable” objects and panoramic images that are transmitted over the Internet provide the end user with limited interaction and give a sense of the 3-D nature of the modeled object/scene. Such content helps some markets (e.g., the e-commerce market and the commercial real estate market) by making the product of interest appear more realistic and tangible to the customer. One class of approaches consists of capturing a large number of images of objects on a rotatable turntable and then, based on the user's control, simply displaying the nearest image to simulate rotating the object.

A traditional interactive 3-D media approach involves estimating 3-D models and then re-projecting the results to create new views. This approach often is highly computational and slow and sometimes requires considerable human intervention to achieve reasonable results.

More recently, image-based rendering (IBR) techniques have focused on using images directly for synthesizing new views. In one approach, two basis images are interpolated to synthesize new views. In another approach, a parametric function is estimated and used to interpolate two views. Some view synthesis schemes exploit constraints of weakly calibrated image pairs. Other schemes use trifocal tensors for view synthesis. In one IBR scheme, edges in three views are matched and then interpolated. These IBR techniques perform well with respect to synthesizing good-looking views. However, they assume dense correspondences have already been established, and in some case, use complex rendering to synthesize new views offline.

### SUMMARY

The invention features systems and methods of multiframe image processing.

In one aspect, the invention features a method of multiframe image processing in accordance with which correspondence mappings from one or more anchor views of a scene to a common reference anchor view are computed, and anchor views are interpolated based on the computed correspondence mappings to generate a synthetic view of the scene.

In another aspect of the invention, correspondence mappings between one or more pairs of anchor views of a scene are computed, a discretized space of synthesizable views referenced to the anchor views of the scene is parameterized, and anchor views in the parameterized discretized space are interpolated based on the computed correspondence mappings to generate a synthetic view of the scene.

In another aspect of the invention, correspondence mappings between one or more pairs of anchor views of a scene are computed. One or more regions occluded from visualizing the scene are identified in a given anchor view, and color information for occluded regions of the given anchor view is computed based on color information in corresponding regions of at least one other anchor view.

In another aspect of the invention, correspondence mappings between two or more pairs of anchor views of a scene are computed, a graphical user interface is presented to a user. The graphical user interface comprises an N-dimensional space of synthesizable views parameterized based on the computed correspondence mappings and comprising an interface shape representing relative locations of the anchor views, wherein N is an integer greater than 0. A synthetic view of the scene is generated by interpolating between anchor views based on the computed correspondence mappings with anchor view contributions to the synthetic view weighted based on a location in the graphical user interface selected by the user.

In another aspect of the invention, a sequence of patterns of light symbols that temporally encode two-dimensional position information in a projection plane with unique light symbol sequence codes is projected onto a scene. Light patterns reflected from the scene are captured at a capture plane of an image sensor. A correspondence mapping between the capture plane and the projection plane is computed based at least in part on correspondence between light symbol sequence codes captured at the capture plane and light symbol sequence codes projected from the projection plane. Calibration parameters for the image sensor are computed based at least in part on the computed correspondence mapping.

In another aspect of the invention, a multiframe image processing method includes the steps of: (a) projecting onto an object a sequence of patterns of light symbols that temporally encode two-dimensional position information in a projection plane with unique light symbol sequence codes; (b) capturing light patterns reflected from the object at a pair of capture planes with optical axes separated by an angle θ; (c) computing a correspondence mapping between the pair of capture planes based at least in part on correspondence between light symbol sequence codes captured at the capture planes and light symbol sequence codes projected from the projection plane; (d) rotating the object through an angle θ; and (e) repeating steps (a)-(d) until the object has been rotated through a prescribed angle.

The invention also features a system for implementing the above-described multiframe image processing methods.

Other features and advantages of the invention will become apparent from the following description, including the drawings and the claims.

### DESCRIPTION OF DRAWINGS

FIG. 1 is diagrammatic view of a correspondence mapping between two camera coordinate systems and a projector coordinate system.

FIG. 2 is a diagrammatic view of an embodiment of a system for estimating a correspondence mapping and multiframe image processing.

FIG. 3 is a diagrammatic view of an embodiment of a system for estimating a correspondence mapping.

FIG. 4 is a flow diagram of an embodiment of a method of estimating a correspondence mapping.

FIG. 5 is a 2-D (two-dimensional) depiction of a three-camera system.

FIG. 6 is a diagrammatic view of an embodiment of a set of multicolor light patterns.

FIG. 7A is a diagrammatic view of an embodiment of a set of binary light patterns presented over time.

FIG. 7B is a diagrammatic view of an embodiment of a set of binary light patterns derived from the set of light patterns of FIG. 7A presented over time.

FIG. 8 is a diagrammatic view of a mapping of a multipixel region from camera space to a projection plane.

FIG. 9 is a diagrammatic view of a mapping of corner points between multipixel regions from camera space to the projection plane.

FIG. 10 is a diagrammatic view of an embodiment of a set of multiresolution binary light patterns.

FIG. 11 is a diagrammatic view of multiresolution correspondence mappings between camera space and the projection plane.

FIG. 12A is an exemplary left anchor view of an object.

FIG. 12B is an exemplary right anchor view of the object in the anchor view of FIG. 12A.

FIG. 12C is an exemplary image corresponding to a mapping of the left anchor view of FIG. 12A to a reference anchor view corresponding to a projector coordinate space.

FIG. 13 is a flow diagram of an embodiment of a method of multiframe image processing.

FIG. 14 is a diagrammatic perspective view of a three-camera system for capturing three respective anchor views of an object.

FIG. 15 is a diagrammatic view of an exemplary interface triangle.

FIG. 16 is a flow diagram of an embodiment of a method of two-dimensional view interpolation.

FIGS. 17A-17C are exemplary anchor views of an object captured by the three-camera system of FIG. 14.

FIGS. 18A-18D are exemplary views interpolated based on two or more of the anchors views of FIGS. 17A-17C.

FIG. 19 is a flow diagram of an embodiment of a method of computing calibration parameters for one or more image sensors.

FIG. 20 is a diagrammatic view of an embodiment of a system for estimating a correspondence mapping.

FIG. 21 is a flow diagram of an embodiment of a method for estimating a correspondence mapping.

FIG. 22 is a diagrammatic top view of an embodiment of an imaging system for capturing anchor views for view interpolation around an object of interest.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

I. Overview

A. Process Overview

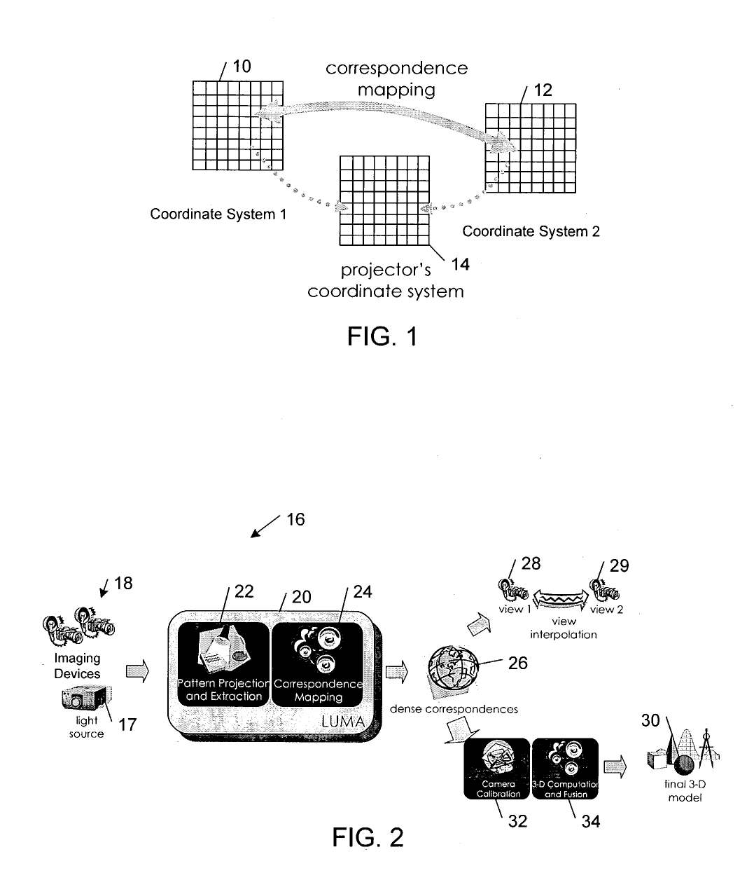

FIG. 1 illustrates an example of a correspondence mapping between the coordinate systems of two imaging devices 10, 12. Each of these coordinate systems is defined with respect to a so-called capture plane. In some embodiments described below, a correspondence mapping is computed by relating each capture plane to a coordinate system 14 that is defined with respect to a so-called projection plane. The resulting mapping may serve, for example, as the first step in camera calibration, view interpolation, and 3-D shape recovery.

The multiframe correspondence estimation embodiments described below may be implemented as reasonably fast and low cost systems for recovering dense correspondences among one or more imaging devices. These embodiments are referred to herein as Light Undulation Measurement Analysis (or LUMA) systems and methods. The illustrated LUMA embodiments include one or more computer-controlled and stationary imaging devices and a fixed light source that is capable of projecting a known light pattern onto a scene of interest. Recovery of the multiframe correspondence mapping is straightforward with the LUMA embodiments described below. The light source projects known patterns onto an object or 3-D scene of interest, and light patterns that are reflected from the object are captured by all the imaging devices. Every projected pattern is extracted in each view and the correspondence among the views is established. Instead of attempting to solve the difficult correspondence problem using image information alone, LUMA exploits additional information gained by the use of active projection. In some embodiments, intelligent temporal coding is used to estimate correspondence mappings, whereas other embodiments use epipolar geometry to determine correspondence mappings. The correspondence mapping information may be used directly for interactive view interpolation, which is a form of 3-D media. In addition, with simple calibration, a 3-D representation of the object's shape may be computed easily from the dense correspondences by the LUMA embodiments described herein.

B. System Overview

Referring to FIG. 2, in some embodiments, a LUMA system 16 for estimating a correspondence mapping includes a light source 17, one or more imaging devices 18, a processing system 20 that is operable to execute a pattern projection and extraction controller 22 and a correspondence mapping calculation engine 24. In operation, pattern projection and extraction controller 22 is operable to choreograph the projection of light patterns onto a scene and the capture of reflected light at each of the imaging devices 18. Based at least in part on the captured light, correspondence mapping calculation engine 24 is operable to compute a correspondence mapping 26 between different views of the scene. The correspondence mapping 26 may be used to interpolate different views 28, 29 of the scene. The correspondence mapping 26 also may be used to compute a 3-D model 30 of the scene after camera calibration 32 and 3-D computation and fusion 34.

In some embodiments, processing system 20 is implemented as a computer (or workstation) and pattern projection and extraction controller 22 and correspondence mapping calculation engine 24 are implemented as one or more software modules that are executable on a computer (or workstation). In general, a computer (or workstation) on which calculation engine 24 may execute includes a processing unit, a system memory, and a system bus that couples the processing unit to the various components of the computer. The processing unit may include one or more processors, each of which may be in the form of any one of various commercially available processors. The system memory typically includes a read only memory (ROM) that stores a basic input/output system (BIOS) that contains start-up routines for the computer, and a random access memory (RAM). The system bus may be a memory bus, a peripheral bus or a local bus, and may be compatible with any of a variety of bus protocols, including PCI, VESA, Microchannel, ISA, and EISA. The computer also may include a hard drive, a floppy drive, and CD ROM drive that are connected to the system bus by respective interfaces. The hard drive, floppy drive, and CD ROM drive contain respective computer-readable media disks that provide non-volatile or persistent storage for data, data structures and computer-executable instructions. Other computer-readable storage devices (e.g., magnetic tape drives, flash memory devices, and digital video disks) also may be used with the computer. A user may interact (e.g., enter commands or data) with the computer using a keyboard and a mouse. Other input devices (e.g., a microphone, joystick, or touch pad) also may be provided. Information may be displayed to the user on a monitor or with other display technologies. The computer also may include peripheral output devices, such as speakers and a printer. In addition, one or more remote computers may be connected to the computer over a local area network (LAN) or a wide area network (WAN) (e.g., the Internet).

There are a variety of imaging devices 18 that are suitable for LUMA. The terms imaging devices, image sensors, and cameras are used interchangeably herein. The imaging devices 18 typically remain fixed in place and are oriented toward the object or scene of interest. Image capture typically is controlled externally. Exemplary imaging devices include computer-controllable digital cameras (e.g., a Kodak DCS760 camera), USB video cameras, and Firewire/1394 cameras. USB video cameras or “webcams,” such as the Intel PC Pro, generally capture images at a rate of 30 fps (frames per second) and a resolution of 320 pixels×240 pixels. The frame rate drastically decreases when multiple cameras share the same bus. Firewire cameras (e.g., Orange Micro's Ibot, Point Grey Research's Dragonfly) offer better resolution and frame rate (e.g., 640 pixels×480 pixels at rate of 30 fps) and may be used simultaneously with many more cameras. For example, in one implementation, four Dragonfly cameras may be on the same Firewire bus capturing VGA resolution at 15 fps or more.

Similarly, a wide variety of different light sources 17 may be used in the LUMA embodiments described below. Exemplary light sources include a strongly colored incandescent light projector with vertical slit filter, laser beam apparatus with spinning mirrors, and a computer-controlled light projector. In some embodiments, the light source 17 projects a distinguishable light pattern (e.g., vertical plane of light or a spatially varying light pattern) that may be detected easily on the object. In some embodiments, the light source and the imaging devices operate in the visible spectrum. In other embodiments, the light source and the imaging devices may operate in other regions (e.g., infrared or ultraviolet regions) of the electromagnetic spectrum. The actual location of the light source with respect to the imaging devices need not be estimated. The illustrated embodiments include a computer-controlled light projector that allows the projected light pattern to be dynamically altered using software.

The LUMA embodiments described herein provide a number of benefits, including automatic, flexible, reasonably fast, and low-cost approaches for estimating dense correspondences. These embodiments efficiently solve dense correspondences and require relatively little computation. These embodiments do not rely on distinct and consistent textures and avoid production of spurious results for uniformly colored objects. The embodiments use intelligent methods to estimate multiframe correspondences without knowledge of light source location. These LUMA embodiments scale automatically with the number of cameras. The following sections will describe these embodiments in greater detail and highlight these benefits. Without loss of generality, cameras serve as the imaging devices and a light projector serves as a light source.

II. Intelligent Temporal Coding

A. Overview

This section describes embodiments that use intelligent temporal coding to enable reliable computation of dense correspondences for a static 3-D scene across any number of images in an efficient manner and without requiring calibration. Instead of using image information alone, an active structured light scanning technique solves the difficult multiframe correspondence problem. In some embodiments, to simplify computation, correspondences are first established with respect to the light projector's coordinate system (referred to herein as the projection plane), which includes a rectangular grid with w×h connected rectangular regions. The resulting correspondences may be used to create interactive 3-D media, either directly for view interpolation or together with calibration information for recovering 3-D shape.

The illustrated coded light pattern LUMA embodiments encode a unique identifier corresponding to each pair of projection plane coordinates by a set of light patterns. The cameras capture and decode every pattern to obtain the mapping from every camera's capture plane to the projection plane. These LUMA embodiments may use one or more cameras with a single projector. In some embodiments, binary colored light patterns, which are oriented both horizontally and vertically, are projected onto a scene. The exact projector location need not be estimated and camera calibration is not necessary to solve for dense correspondences. Instead of solving for 3-D structure, these LUMA embodiments address the correspondence problem by using the light patterns to pinpoint the exact location in the projection plane. Furthermore, in the illustrated embodiments, the decoded binary sequences at every image pixel may be used directly to determine the location in the projection plane without having to perform any additional computation or searching.

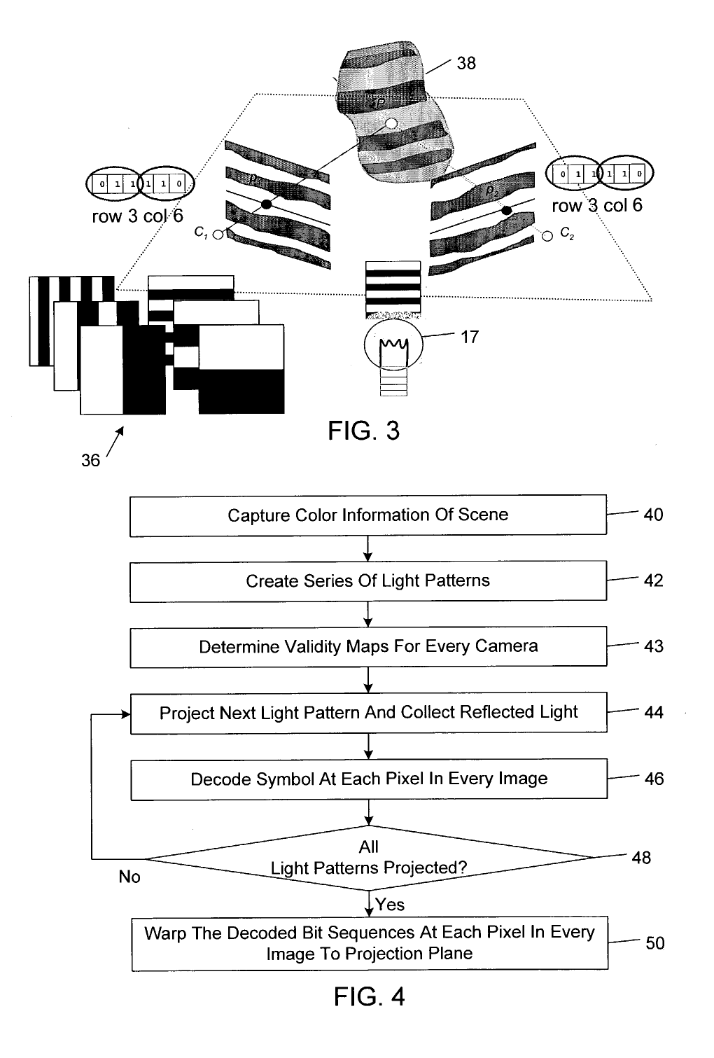

Referring to FIG. 3, in one embodiment, the exemplary projection plane is an 8×8 grid, where the lower right corner is defined to be (0,0) and the upper left corner is (7,7). Only six light patterns 36 are necessary to encode the sixty-four positions. Each pattern is projected onto an object 38 in succession. Two cameras C₁, C₂ capture the reflected patterns, decode the results, and build up bit sequences at every pixel location in the capture planes. Once properly decoded, the column and row may be immediately determined. Corresponding pixels across cameras will automatically decode to the same values. In the illustrated embodiment, both p1 and p2 decode to (row, column)=(3,6).

The following notation will be used in the discussion below. Suppose there are K+1 coordinate systems (CS) in the system, where the projection plane is defined as the 0^{th} coordinate system and the K cameras are indexed 1 through K. Let lowercase boldface quantities such as p represent a 2-D point (pᵤ,pᵥ) in local coordinates. Let capital boldface quantities such as P represent a 3-D vector (pₓ,p_{y},p_{z}) in the global coordinates. Suppose there are a total of N light patterns to be displayed in sequence, indexed 0 through N-1. Then, define image function Iₖ(p;n)=C as the three-dimensional color vector C of CS k at point p corresponding to light pattern n. Note that I₀(•;n) represents the actual light pattern n defined in the projection plane. Denote Vₖ(p) to be the indicator function at point p in camera k. A point p in camera k is defined to be valid if and only if Vₖ(p)=1. Define the mapping function Mᵢⱼ(p)=q for point p defined in CS i as the corresponding point q defined in CS j. Note that these mappings are bi-directional, i.e. if Mᵢⱼ(p)=q, then Mⱼᵢ(q)=p. Also, if points in two CS's map to the same point in a third CS (i.e. Mᵢₖ(P)=Mⱼₖ(r)=q), then Mᵢⱼ(p)=Mₖⱼ(Mᵢₖ(p))=r.

The multiframe correspondence problem is then equivalent to the following: project a series of light patterns I₀(•;n) and use the captured images Iₖ(•;n) to determine the mappings Mᵢⱼ(p) for all valid points p and any pair of cameras i and j. The mappings may be determined for each camera independently with respect to the projection plane since from above

Mᵢⱼ(p)=M₀ⱼ(Mᵢ₀(p)).

Referring to FIG. 4, in some embodiments, the LUMA system of FIG. 3 for estimating multiframe correspondences may operate as follows.

1. Capture the color information of the 3-D scene 38 from all cameras (step 40). These images serve as the color texture maps in the final representation.

2. Create the series of light patterns 36 to be projected (step 42). This series includes reference patterns that are used for estimating the projected symbols per image pixel in the capture plane.

3. Determine validity maps for every camera (step 43). For every pixel p in camera k, Vₖ(p)=1 when the inter-symbol distance (e.g. the l₂ norm of the difference of every pair of mean color vectors) is below some preset threshold. The invalid pixels correspond to points that lie outside the projected space or that do not offer enough discrimination between the projected symbols (e.g. regions of black in the scene absorb the light).

4. In succession, project each coded light pattern onto the 3-D scene of interest and capture the result from all cameras (step 44). In other words, project I₀(•;m) and capture Iₖ(•;m) for camera k and light pattern m. In this process, the projector and the cameras are synchronized.

5. For every light pattern, decode the symbol at each valid pixel in every image (step 46). Because of illumination variations and different reflectance properties across the object, the decision thresholds vary for every image pixel. The reference images from step 2 help to establish a rough estimate of the symbols at every image pixel. Every valid pixel is assigned the symbol corresponding to the smallest absolute difference between the perceived color from the captured light pattern and each of the symbol mean colors. The symbols at every image pixel then are estimated by clustering the perceived color and bit errors are corrected using filtering.

6. Go to step 44 and repeat until all light patterns in the series have been used (step 48). Build up bit sequences at each pixel in every image.

7. Warp the decoded bit sequences at each pixel in every image to the projection plane (step 50). The bit sequences contain the unique identifiers that are related to the coordinate information in the projection plane. The image pixel's location is noted and added to the coordinate in the projection plane array. To improve robustness and reduce sparseness in the projection plane array, entire quadrilateral patches in the image spaces, instead of single image pixels, may be warped to the projection plane using traditional computer graphics scanline algorithms. Once all images have been warped, the projection plane array may be traversed, and for any location in the array, the corresponding image pixels may be identified immediately across all images.

In the end, the correspondence mapping Mₖ₀(•) between any camera k and the projection plane may be obtained. These mappings may be combined as described above to give the correspondence mapping Mᵢⱼ(p)=M₀ⱼ(Mᵢ₀(p)) between any pair of cameras i and j for all valid points p.

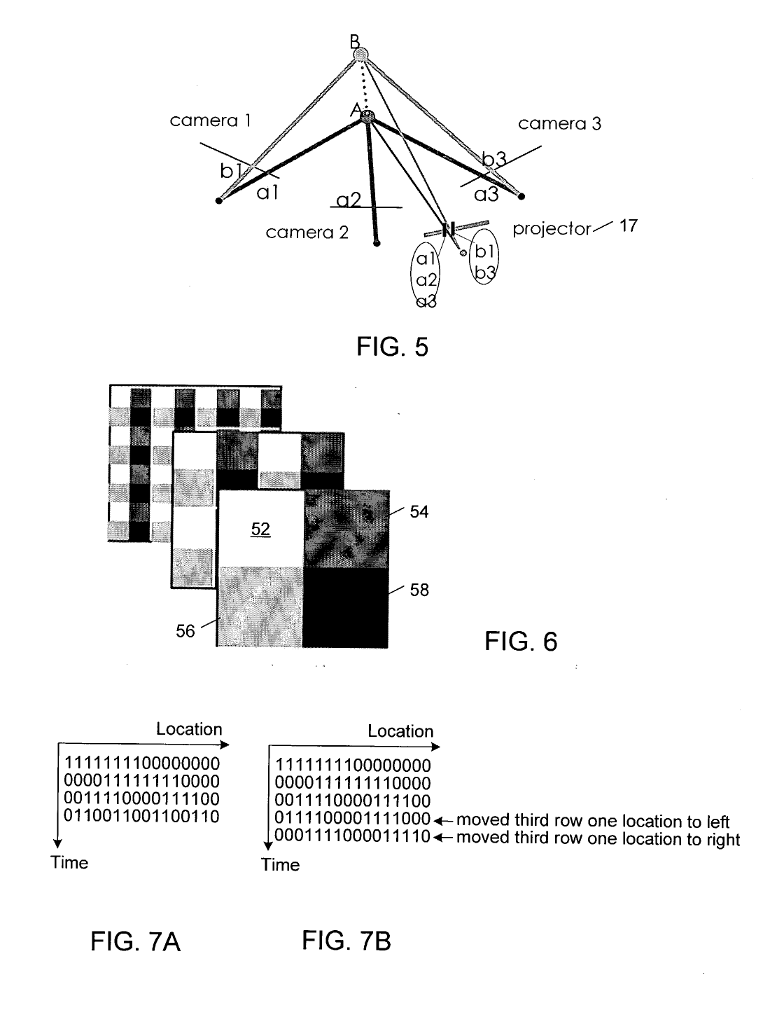

Referring to FIG. 5, in one exemplary illustration of a 2-D depiction of a three-camera system, correspondence, occlusions, and visibility among all cameras may be computed automatically with the above-described approach without additional computation as follows. The light projector 17 shines multiple coded light patterns to encode the location of the two points, points A and B.

These patterns are decoded in each of the three cameras. Scanning through each camera in succession, it is found that point a1 in camera 1 maps to the first location in the projection plane while b1 maps to the second location in the projection plane. Likewise for camera 3, points a3 and b3 map to the first and second locations, respectively, in the projection plane. Finally, a2 in camera 2 maps to the first location, and it is found that there are no other image pixels in camera 2 that decode to the second location because the scene point corresponding to the second location in the projection plane is occluded from camera 2's viewpoint. An array (i.e., the light map data structure described below) may be built up in the projection plane that keeps track of the original image pixels. This array may be traversed to determine correspondences. The first location in the projection plane contains the three image pixels a1, a2, and a3, suggesting that (a) all three cameras can see this particular point A, and (b) the three image pixels all correspond to one another. The second location in the projection plane contains the two image pixels b1 and b3 implying that (a) cameras 1 and 3 can view this point B, (b) the point must be occluded in camera 2, and (c) only b1 and b3 correspond.

The above-described coded light pattern LUMA embodiments provide numerous benefits. Dense correspondences and visibility may be computed directly across multiple cameras without additional computationally intensive searching. The correspondences may be used immediately for view interpolation without having to perform any calibration. True 3-D information also may be obtained with an additional calibration step. The operations are linear for each camera and scales automatically for additional cameras. There also is a huge savings in computation using coded light patterns for specifying projection plane coordinates in parallel. For example, for a 1024×1024 projection plane, only 22 binary colored light patterns (including the two reference patterns) are needed. In some implementations, with video rate (30 Hz) cameras and projector, a typical scene may be scanned in under three seconds.

Given any camera in the set up, only scene points that are visible to that camera and the projector are captured. In other words, only the scene points that lie in the intersection of the visibility frustum of both systems may be properly imaged. Furthermore, in view interpolation and 3-D shape recovery applications, only scene points that are visible in at least two cameras and the projector are useful. For a dual-camera set up, the relative positions of the cameras and the projector dictate how sparse the final correspondence results will be. Because of the scalability of these LUMA embodiments, this problem may be overcome by increasing the number of cameras.

B. Coded Light Patterns

1. Binary Light Patterns

Referring back to FIG. 3, in the illustrated embodiment, the set of coded light patterns 36 separate the reference coordinates into column and row: one series of patterns to identify the column and another series to identify the row. Specifically, a set of K+L binary images representing each bit plane is displayed, where K=log₂(w) and L=log₂(h) for a wxh projection plane. This means that the first of these images (coarsest level) consists of a half-black-half-white image while the last of these images (finest level) consists of alternating black and white lines. To make this binary code more error resilient, the binary representation may be converted to a Gray code using known Gray-coding techniques to smooth black-white transition between adjacent patterns. In this embodiment, reference patterns consisting of a full-illumination (“all white”) pattern, and an ambient (“all black”),pattern are included. Note that only the intensity of the images is used for estimation since the patterns are strictly binary.

2. Multicolor Light Patterns

Referring to FIG. 6, in another embodiment, a base-4 encoding includes different colors (e.g., white 52, red 54, green 56, and blue 58) to encode both vertical and horizontal positions simultaneously. In this manner, only N base-4 images are required, where N=log₄(w×h). An exemplary pattern is shown in FIG. 6 for an 8×8 reference grid. The upper left location in the reference grid consists of (white, white, white, white, white, white) for the base-2 encoding of FIG. 3 and (white, white, white) for the base-4 encoding of FIG. 6. The location immediately to its right in the projection plane is (white, white, white, white, white, black) for base-2 and (white, white, red) in the base-4 encoding, and so forth for other locations. In this embodiment, reference patterns consist of all white, all red, all green, and all blue patterns.

3. Error Resilient Light Patterns

To overcome decoding errors, error resiliency may be incorporated into the light patterns so that the transmitted light patterns may be decoded properly. While adding error resiliency will require additional patterns to be displayed and hence reduce the speed of the capture process, it will improve the overall robustness of the system. For example, in some embodiments, various conventional error protection techniques (e.g. pattern replication, (7, 4) Hamming codes, soft decoding, other error control codes) may be used to protect the bits associated with the higher spatial frequency patterns and help to recover single bit errors.

In some embodiments, which overcome problems associated with aliasing, a sweeping algorithm is used. As before, coded light patterns are first projected onto the scene. The system may then automatically detect the transmitted light pattern that causes too much aliasing and leads to too many decoding errors. The last pattern that does not cause aliasing is swept across to discriminate between image pixels at the finest resolution.

For example, referring to FIG. 7A, in one exemplary four-bit Gray code embodiment, each row corresponds to a light pattern that is projected temporally while each column corresponds to a different pixel location (i.e., the vertical axis is time and the horizontal axis is spatial location). Suppose the highest resolution pattern (i.e., the very last row) produces aliasing. In this case, a set of patterns is used where this last row pattern is replaced by two new patterns, each consisting of the third row pattern “swept” in key pixel locations; the new pattern set is displayed in FIG. 7B. Notice that the new patterns are simply the third row pattern moved one location to the left and right, respectively. In these embodiments, the finest spatial resolution pattern that avoids aliasing is used to sweep the remaining locations. This approach may be generalized to an arbitrary number of light patterns with arbitrary spatial resolution. In some embodiments, a single pattern is swept across the entire spatial dimension.

C. Mapping Multipixel Regions

In the above-described embodiments, the same physical point in a scene is exposed to a series of light patterns, which provides its representation. A single camera may then capture the corresponding set of images and the processing system may decode the unique identifier representation for every point location based on the captured images. The points seen in the image may be mapped directly to the reference grid without any further computation. This feature is true for any number of cameras viewing the same scene.

The extracted identifiers are consistent across all the images. Thus, a given point in one camera may be found simply by finding the point with the same identifier; no additional computation is necessary. For every pair of cameras, the identifiers may be used to compute dense correspondence maps. Occlusions are handled automatically because points that are visible in only one camera will not have a corresponding point in a second camera with the same identifier.

In some embodiments, the coded light patterns encode individual point samples in the projection plane. As mentioned in the multiframe correspondence estimation method described above in connection with FIG. 4, these positions are then decoded in the capture planes and warped back to the appropriate locations in the projection plane. In the following embodiments, a correspondence mapping between multipixel regions in a capture plane and corresponding regions in a projection plane are computed in ways that avoid problems, such as sparseness and holes in the correspondence mapping, which are associated with approaches in which correspondence mappings between individual point samples are computed.

1. Mapping Centroids

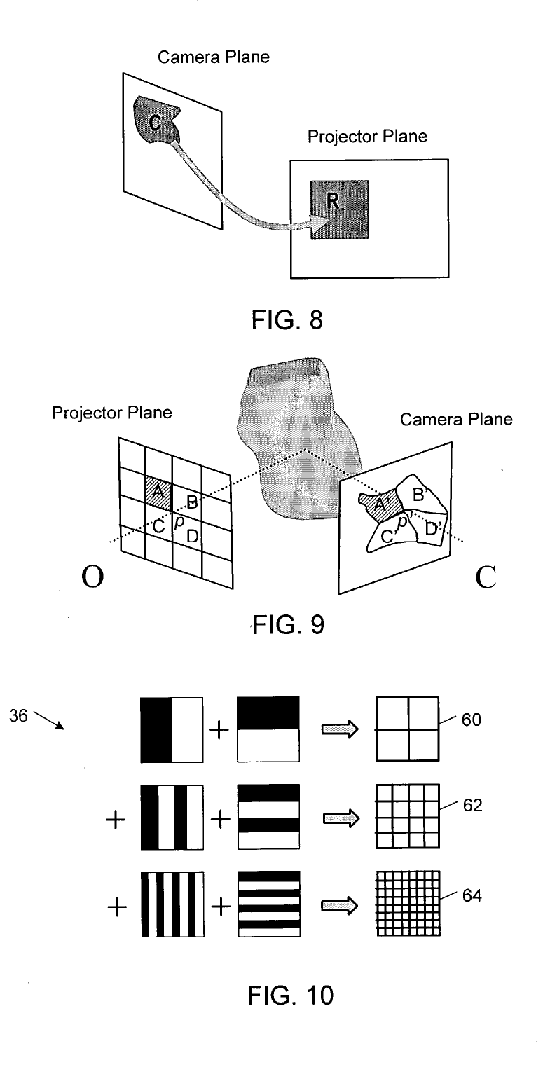

Referring to FIG. 8, in some embodiments, the centroids of neighborhoods in a given camera's capture plane are mapped to corresponding centroids of neighborhoods in the projection plane. The centroids may be computed using any one of a wide variety of known techniques. One approach to obtain this mapping is to assume a translational model as follows:

Compute the centroid (u_{c}, v_{c}) and approximate dimensions (w_{c}, h_{c}) of the current cluster C in a given capture plane.

Compute the centroid (uᵣ, vᵣ) and approximate dimensions (wᵣ, hᵣ) of the corresponding region R in the projection plane.

Map each point (u,v) in C to a new point in R given by (w_{c}*(u−u_{c})+uᵣ, wᵣ*(v−v_{c})+vᵣ). That is, the distance the point in C is away from the centroid is determined and the mapping is scaled to fit within R.

In some embodiments, hierarchical ordering is used to introduce scalability to the correspondence results. In these embodiments, the lowest resolution patterns are first projected and decoded. This provides a mapping between clusters in the cameras' space to regions in the projection plane. The above-described mapping algorithm may be applied at any resolution. Even if not all the light patterns are used, the best mapping between the cameras and the projector may be determined by using this method. This mapping may be computed for every resolution, thereby creating a multiresolution set of correspondences. The correspondence mapping then may be differentially encoded to efficiently represent the correspondence. The multiresolution set of correspondences also may serve to validate the correspondent for every image pixel, since the correspondence results should be consistent across the resolutions.

In these embodiments, local smoothness may be enforced to ensure that the correspondence map behaves well. In some embodiments, other motion models (e.g. affine motion, splines, homography/perspective transformation) besides translational motion models may be used to improve the region mapping results.

2. Mapping Corner Points

Referring to FIG. 9, in an exemplary 4×4 projection plane embodiment, after decoding, the set of image points A′ is assigned to rectangle A in the projection plane, however the exact point-to-point mapping remains unclear. Instead of mapping interior points, the connectedness of the projection plane rectangles is exploited to map corner points that border any four neighboring projection plane rectangles. For example, the corner point p that borders A, B, C, D in the projection plane corresponds to the image point that borders A′, B′, C′, D′, or in other words, the so-called imaged corner point p′.

As shown in FIG. 10, the coded light patterns 36 of FIG. 3 exhibit a natural hierarchical spatial resolution ordering that dictates the size of the projection plane rectangles. The patterns are ordered from coarse to fine, and each associated pair of vertical-horizontal patterns at the same scale subdivides the projection plane by two in both directions. Using the coarsest two patterns alone results in only a 2×2 projection plane 60. Adding the next pair of patterns increases the projection plane 62 to 4×4, with every rectangle's area reduced by a fourth, and likewise for the third pair of patterns. All six patterns encode an 8×8 projection plane 64.

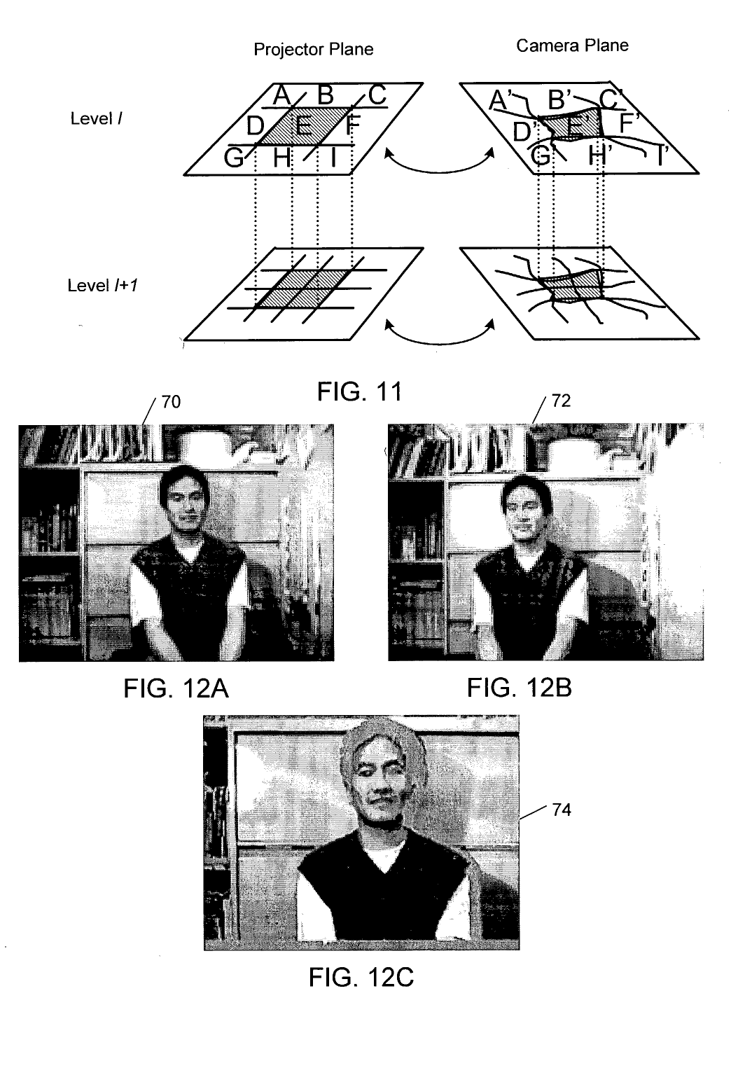

Referring to FIG. 11, in some embodiments, since it may be difficult in some circumstances to locate every corner's match at the finest projection plane resolution, each corner's match may be found at the lowest possible resolution and finer resolutions may be interpolated where necessary. In the end, subpixel estimates of the imaged corners at the finest projection plane resolution are established. In this way, an accurate correspondence mapping from every camera to the projection plane may be obtained, resulting in the implicit correspondence mapping among any pair of cameras.

In these embodiments, the following additional steps are incorporated into the algorithm proposed in Section II.A. In particular, before warping the decoded symbols (step 50; FIG. 4), the following steps are performed.

1. Perform coarse-to-fine analysis to extract and interpolate imaged corner points at finest resolution of the projection plane. Define Bₖ(q) to be the binary map for camera k corresponding to location q in the projection plane at the finest resolution, initially all set to 0. A projection plane location q is said to be marked if and only if Bₖ(q)=1. For a given resolution level l, the following substeps are performed for every camera k:

a. Convert bit sequences of each image point to the corresponding projection plane rectangle at the current resolution level. For all valid points p, the first l decoded symbols are decoded and used to determine the coordinate (c,r) in the 2^{l+1}×2^{l+1} projection plane. For example, in the case of binary light patterns, the corresponding column c is simply the concatenation of the first l decoded bits, and the corresponding row r is the concatenation of the remaining bits. Hence, Mₖₒ(p)=(c,r).

b. Locate imaged corner points corresponding to unmarked corner points in the projection plane. Suppose valid point p in camera k maps to unmarked point q in the projection plane. Then, p is an imaged corner candidate if there are image points within a 5×5 neighborhood that map to at least three of q's neighbors in the projection plane. In this way, the projection plane connectivity may be used to overcome possible decoding errors due to specularities and aliasing. Imaged corners are found by spatially clustering imaged corner candidates together and computing their subpixel averages. Set Bₖ(q)=1 for all corner points q at the current resolution level.

c. Interpolate remaining unmarked points in the projection plane at the current resolution level. Unmarked points with an adequate number of defined nearest neighbors are bilaterally interpolated from results at this or coarser levels.

d. Increment l and repeat steps a-c for all resolution levels l. The result is a dense mapping M₀ₖ(•) of corner points in the projection plane to their corresponding matches in camera k.

In some embodiments, different known corner detection/extraction algorithms may be used.

2. Validate rectangles in the projection plane. For every point (c,r) in the projection plane, the rectangle with vertices {(c,r),(c+1,r),(c+1,r+1),(c,r+1)} is valid if and only if all its vertices are marked and they correspond to valid points in camera k.

D. Constructing a Light Map of Correspondence Mappings

In some of the above-described embodiments, the coded light patterns are defined with respect to the projector's coordinate system in the projection plane and every camera's view is therefore defined through the projector's coordinate system. As a result, the correspondence mapping of every camera is defined with respect to the projection plane. In some of these embodiments, a data structure, herein referred to as a light map, may be built from the decoded image data to represent the correspondence mappings. The light map consists of an array of points defined in the projection plane, where every point in this plane points to a linked list of image pixels from the different cameras such that the image pixels correspond to the same part of the scene. To build a light map, each camera's color and pixel information are warped to the projector's coordinate system. Every pixel is matched with the corresponding location in the light map according to the decoded identifiers. In some embodiments, computer graphics scanline algorithms are used to warp quadrilateral patches instead of discrete points of the image to the light map as described above. In the end, the contribution from each camera to the light map consists of fairly dense color and pixel information. The light map structure automatically establishes correspondence among the image pixels of any number of cameras, in contrast to examining the mapping between every pair of cameras (see, e.g., the 2-D example in FIG. 5). The light map structure also may be used as a fast way to perform multiframe view interpolation through parameters, as discussed in detail below. Between any camera and the projection plane, only points that are visible to both have representation. Thus, there will be gaps or holes in the light map structure because of occlusions with respect to the given camera. In some embodiments, the missing data from one camera may be estimated by using data from other cameras, as explained in detail below.

As shown in FIGS. 12A, 12B, and 12C, in one exemplary implementation, the two-camera embodiment of FIG. 3 may be used to capture left and right images 70, 72 of a scene. Using the above coded light pattern scheme, a dense correspondence mapping between left and right images 70, 72 and the projection plane is determined automatically. The mapping from the left image can be automatically transformed to the projection plane via the light map; this result is shown as the image 74. In the illustrated example, the grey colored regions in the projector view image 74 correspond to missing data in the light map. In particular, these grey colored regions correspond to occluded regions that are visible from the projector's viewpoint but not the camera's viewpoint (e.g., the right of the person's head and arm are not visible from the camera's viewpoint). Also, it is noted that very dark colored regions in the scene (e.g., the hair, pupils of the eye), which absorb the projector light, are not properly decoded and therefore appear grey colored in image 74. Using the correspondence mapping, the right image 72 also may be transformed to the projector view and incorporated into the light map data. From the resulting light map data, views may be interpolated very easily, as described in detail below.

III. View Interpolation

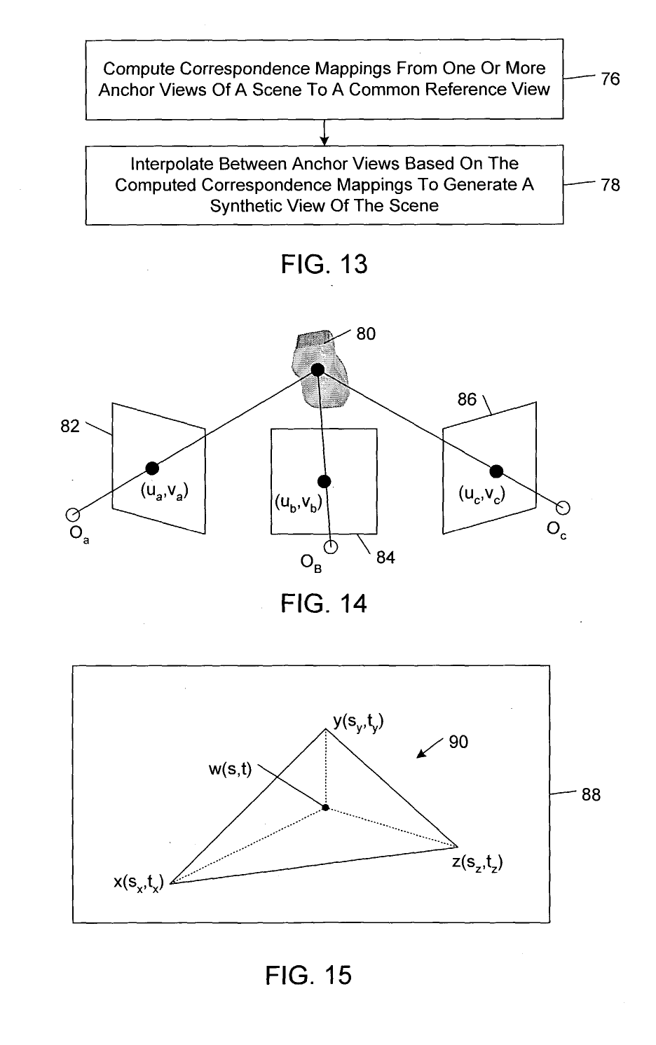

Referring to FIG. 13, in some embodiments, a synthetic view (or image) of a scene may be generated as follows. As used herein, a synthetic view refers to an image that is derived from a combination of two or more views (or images) of a scene. Initially, correspondence mappings from one or more anchor views of the scene to a common reference anchor view are computed (step 76). As used herein, the term “anchor view” refers to an image of a scene captured from a particular viewpoint. An anchor view may correspond to a camera view or, if the aforementioned LUMA embodiments are used to determine correspondences, it may correspond to the projector view, in which case it is referred to as a reference anchor view. In some embodiments, the correspondence mappings are stored in a light map data structure that includes an array of points defined in a reference anchor view space and linked to respective lists of corresponding points in the one or more other anchor views. A synthetic view of the scene is generated by interpolating between anchor views based on the computed correspondence mappings (step 78).

In general, at least two anchor views are required for view interpolation. View interpolation readily may be extended to more than two anchor views. In the embodiments described below, view interpolation may be performed along one dimension (linear view interpolation), two dimensions (a real view interpolation), three dimensions (volume-based view interpolation), or even higher dimensions. Because there is an inherent correspondence mapping between a camera and the projection plane, the reference anchor view corresponding to the projector view may also be used for view interpolation. Thus, in some embodiments, view interpolation may be performed with a single camera. In these embodiments, the interpolation transitions linearly between the camera's location and the projector's location.

A. Linear View Interpolation

Linear view interpolation involves interpolating color information as well as dense correspondence or geometry information defined among two or more anchor views. In some embodiments, one or more cameras form a single ordered contour or path relative to the object/scene (e.g., configured in a semicircle arrangement). A single parameter specifies the desired view to be interpolated, typically between pairs of cameras. In some embodiments, the synthetic views that may be generated span the interval [0,M] with the anchor views at every integral value. In these embodiments, the view interpolation parameter is a floating point value in this expanded interval. The exact number determines which pair of anchor views are interpolated between (the floor and ceiling( ) of the parameter) to generate the synthetic view. In some of these embodiments, successive pairs of anchor views have equal separation of distance 1.0 in parameter space, independent of their actual configuration. In other embodiments, the space between anchor views in parameter space is varied as a function of the physical distance between the corresponding cameras.

In some embodiments, a synthetic view may be generated by linear interpolation as follows. Without loss of generality, the following discussion will focus only on interpolation between a pair of anchor views. A viewing parameter ox that lies between 0 and 1 specifies the desired viewpoint. Given α, a new image quantity p is derived from the quantities p₁ and P₂ associated with the first and second anchor views, respectively, by linear interpolation

p=(1−α)p₁+αp₂=p₁+α(p₂−p₁)

In some embodiments, a graphical user interface may display a line segment between two points representing the two anchor views. A user may specify a value for α corresponding to the desired synthetic view by selecting a point along the line segment being displayed. A new view is synthesized by applying this expression five times for every image pixel to account for the various imaging quantities (pixel coordinates and associated color information). More specifically, suppose a point in the 3-D scene projects to the image pixel (u,v) with generalized color vector c in the first anchor view and to the image pixel (u′,v′) with color c′ in the second anchor view. Then, the same scene point projects to the image pixel (x,y) with color d in the desired synthetic view of parameter α given by:

(x,y)=((1−α)*u+α*u′,(1−α)*v+α*v′)=(u+α*(u−u′),v+α*(v−v′))

d=(1−α)*c+α*c′=c+α*(c−c′)

The above formulation reduces to the first anchor view for α=0 and the second anchor view for α=1. This interpolation provides a smooth transition between the anchor views in a manner similar to image morphing, except that parallax effects are properly handled through the use of the correspondence mapping. In this formulation, only scene points that are visible in both anchor views (i.e., points that lie in the intersection of the visibility spaces of the anchor views) may be properly interpolated.

In some embodiments, integer math and bitwise operations are used to reduce the number of computations that are required to interpolate between anchor views. In these embodiments, it is assumed that there is only a N=2ⁿ finite range of allowable α's. Then, α=floor(α*N) is defined to be the quantized version of α in the range of [0,N]. Note that α≈α/N. Hence, the interpolation equation becomes

v≈v₁+(α/N)(v₂−v₁)=(Nv₁+α(v₂−v₁))/N=((v₁<<n)+α*(v₂−v₁))>>n

where “<<” and “>>” refer to the C/C++ operators for bit shifting left and right, respectively. In this new formulation, only one floating-point cast is required and each of the five imaging quantities may be computed using simple integer math and bitwise operations, enabling typical view interpolations to be computed at interactive rates.

B. Multi-Dimensional View Interpolation

Some embodiments perform multi-dimensional view interpolation as follows. These embodiments handle arbitrary camera configurations and are able to synthesize a large range of views. In these embodiments, two or more cameras are situated in a space around the scene of interest. The cameras and the projection plane each corresponds to an anchor view that may contribute to a synthetic view that is generated. Depending upon the specific implementation, three of more anchor views may contribute to each synthetic view.

As explained in detail below, a user may specify a desired viewpoint for the synthetic view through a graphical user interface. The anchor views define an interface shape that is presented to the user, with the viewpoint of each anchor view corresponding to a vertex of the interface shape. In the case of three anchor views, the interface shape corresponds to a triangle, regardless of the relative positions and orientations of the anchor views in 3-D space. When there are more than three anchor views, the user may be presented with an interface polygon that can be easily subdivided into adjacent triangles or with a higher dimensional interface shape (interface polyhedron or hypershape). An example of four anchor views could consist of an interface quadrilateral or an interface tetrahedron. The user can specify an increased number of synthesizable views as the dimension of the interface shape increases, however higher dimensional interface shapes are harder to visualize and manipulate. The user may use a pointing device (e.g., a computer mouse) to select a point relative to the interface shape that specifies the viewpoint from which a desired synthetic view should be rendered. In some embodiments, this selection also specifies the appropriate anchor views from which the synthetic view should be interpolated as well as the relative contribution of each anchor view to the synthetic view.

The following embodiments correspond to a two-dimensional view interpolation implementation. In other embodiments, however, view interpolation may be performed in three or higher dimensions.

In the following description, it is assumed that two or more cameras are arranged in a ordered sequence around the object/scene. An example of such an arrangement is a set of cameras with viewpoints arranged in a vertical (x-y) plane that is positioned along the perimeter of a rectangle in the plane and defining the vertices of an interface polygon. With the following embodiments, the user may generate synthetic views from viewpoints located within or outside of the contour defined along the anchor views as well as along this contour. In some embodiments, the space of virtual (or synthetic) views that can be generated is represented and parameterized by a two-dimensional (2-D) space that corresponds to a projection of the space defined by the camera configuration boundary and interior.

Referring to FIG. 14, in some embodiments, a set of three cameras a, b, c with viewpoints Oₐ, O_{b}, O_{c} arranged in a plane around an object 80. Assuming that synthetic views will be generated from anchor views from the three cameras, viewpoints Oₐ, O_{b}, O_{c} define the vertices of an interface triangle. Images of the object 80 are captured at respective capture planes 82, 84, 86 and a light map of correspondence mappings between the cameras and the projection plane are computed in accordance with one or more of the above-described LUMA embodiments. The pixel coordinate information captured at the capture planes 82, 84, 86 is denoted by (uₐ,vₐ), (u_{b},v_{b}), (u_{c},v_{c}), respectively.

In some of these embodiments, the space corresponding to the interface triangle is defined with respect to the above-described light map representation as follows.

Identify locations in the light map that have contributions from all the cameras (i.e., portions of the scene visible in all cameras).

For every location, translate the correspondence information from each camera in succession to difference vectors. For example, suppose location (x,y) in the light map consists of the correspondence information (u1,v1), (u2,v2), and (u3,v3) from cameras 1, 2, and 3, respectively. Then, the difference vectors become (u1−x,v1−y), (u2−x,v2−y), and (u3−x,v3−y). The difference vectors specify the ordered vertices of the two-dimensional projection of the space of synthesizable views corresponding to the interface triangle.

Referring to FIG. 15, in some embodiments, a user may select a desired view of the scene through a graphical user interface 88 displaying an interface triangle 90 with vertices representing the viewpoints of each of the camera of FIG. 14. If there were more than three anchor views, the graphical user interface 88 would display to the user either an interface polygon with vertices representing the viewpoints of the anchor views or a projection of a higher dimension interface shape. The interface triangle 90 gives an abstract 2-D representation of the arrangement of the cameras. The user may use a pointing device (e.g., a computer mouse) to select a point w(s,t) relative to the interface triangle 90 that specifies the viewpoint from which a desired synthetic view should be rendered and the contribution of each anchor view to the desired synthetic view. The user may perform linear view interpolation between pairs of anchor views simply by traversing the edges of the interface triangle. The user also may specify a location outside of the interface triangle in the embodiment of FIG. 15, in which case the system would perform view extrapolation (or view synthesis).

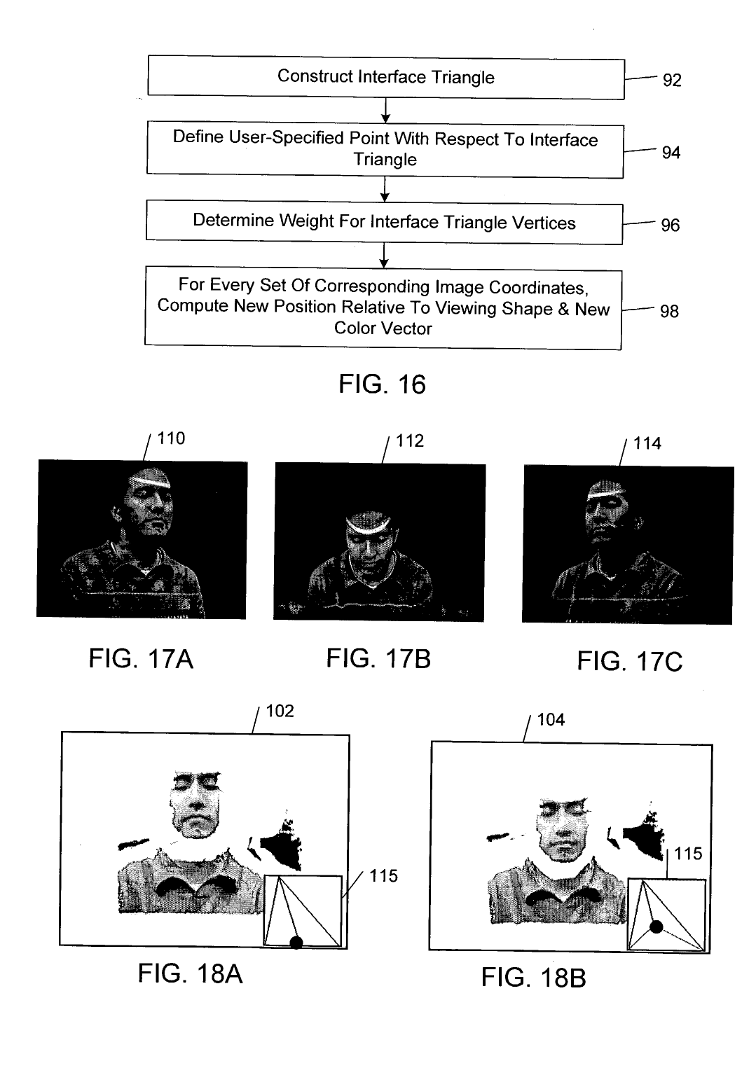

Referring to FIG. 16, in some embodiments, the Barycentric coordinates of the user selected point are used to weight the pixel information from the three anchor views to synthesize the desired synthetic view, as follows:

Construct an interface triangle Δxyz (step 92): Let x=(0,0). Define y-x to be the median of correspondence difference vectors between cameras b and a, and likewise, z-y for cameras c and b.

Define a user-specified point w=(s,t) with respect to Δxyz (step 94).

Determine Barycentric coordinates (α,β,γ) corresponding respectively to the weights for vertices x, y, z (step 96):

Compute signed areas (SA) of sub-triangles formed by the vertices of the interface triangle and the user selected point w, i.e., SA(x,y,w), SA(y,z,w), SA(z,x,w), where for vertices x=(sₓ,tₓ), y=(s_{y},t_{y}),z=(s_{z},t_{z}),

SA(x,y,z)=½((t_{y}−tₓ)s_{z}+(sₓ−s_{y})t_{z}+(s_{y}tₓ−sₓt_{y}))

Note that the signed area is positive if the vertices are oriented clockwise and negative otherwise.

Calculate (possibly negative) weights α,β,γ based on relative subtriangle areas, such that

α=SA(y,z,w)/SA(x,y,z)

β=SA(z,x,w)/SA(x,y,z)

γ=SA(x,y,w)/SA(x,y,z)=1−α−β

For every triplet (a,b,c) of corresponding image coordinates, use a weighted combination to compute the new position p=(u,v) relative to Δabc (step 98), i.e.

u=αuₐ+βu_{b}+γu_{c}

v=αvₐ+βv_{b}+γv_{c}

Note that the new color vector for the synthetic image is similarly interpolated. For example, assuming the color of anchor views a, b, c are given by cᵤ, c_{b}, c_{c}, the color d of the synthetic image is given by:

d=α*cₐ+β*c_{b}+γ*c_{c}

In some embodiments, more than three anchor views are available for view interpolation. In these embodiments, a graphical user interface presents to the user an interface shape of two or more dimensions with vertices representing each of the anchor views.

The above-described view interpolation embodiments automatically perform three-image view interpolation for interior points of the interface triangle. View interpolation along the perimeter is reduced to pair-wise view interpolation. These embodiments also execute view extrapolation for exterior points. In these embodiments, calibration is not required. In these embodiments, a user may select an area outside of the pre-specified parameter range. In some embodiments, the above-described method of computing the desired synthetic view may be modified by first sub-dividing the interface polygon into triangles and selecting the closest triangle to the user-selected location. The above-described view interpolation method then is applied to the closest triangle.

In other embodiments, the above-described approach is modified by interpolating between more than three anchor views, instead of first subdividing the interface polygon into triangles. The weighted contribution of each anchor view to the synthetic view is computed based on the relative position of the user selected location P to the anchor view vertices of the interface triangle. The synthetic views are generated by linearly combining the anchor view contributions that are scaled by the computed weights. In some embodiments, the weighting function is based on the l₂ distance (or l₂ norm) of the user selected location to the anchor view vertices. In other embodiments, the weighting function is based on the respective areas of subtended polygons.

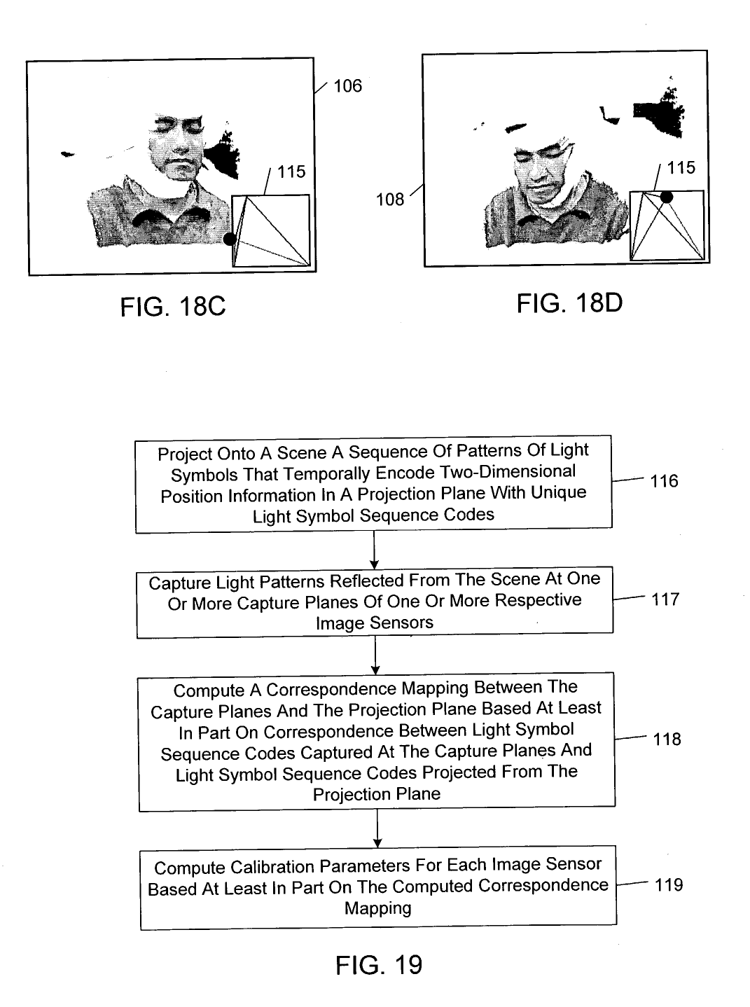

Referring to FIGS. 17A, 17B, 17C, 18A, 18B, 18C, and 18D, in one implementation of the above-described three-camera view interpolation embodiments, different synthetic views 102, 104, 106, 108 of a scene may be interpolated based on three anchor views 110, 112, 114 that are respectively captured by the cameras. In this implementation, the three cameras capture a human subject in a so-called “Face” triplet. The dark regions that appear in the synthetic views correspond to portions of a drop cloth that is located behind the captured object; note that the above-described LUMA embodiments properly determine the correspondences for these points as well. An interface triangle 115, which is located in the lower right corner of each image 102, 104, 106, 108, shows the user's viewpoint as a dark circle and its relative distance to each camera or vertex. The synthetic image 102 is a view interpolation between the anchor views 110, 114. The synthetic image 104 shows the result of interpolating using all three anchor views 110, 112, 114. The last two synthetic images 106, 108 are extrapolated views that go beyond the interface triangle 115. The subject's face and shirt are captured well and appear to move naturally during view interpolation. The neck does not appear in the synthesized views 102, 104, 106, 108 because it is occluded in the top anchor view 112. The resulting views are quite dramatic, especially when seen live, because of the wide separation among cameras.

In some embodiments, integer math and bitwise operations are used to reduce the number of computations that are required to interpolate between anchor views. In these embodiments, the parameter space is discretized to reduce the number of allowable views. In particular, each real parameter interval [0,1] is remapped to the integral interval [0,N], where N=2ⁿ is a power of two. In the following implementation, three anchor views are interpolated; this implementation may be readily extended to the case of more than three anchor views. Let α=(int)(α*N) and b=(int)(β*N) be the new integral view parameters. Then, the generic interpolation expression between quantities p₁, p₂ and p₃ may be reduced as follows:

$$q = α {p}_{1} + β {p}_{2} + γ {p}_{3} = {p}_{3} + α ( {p}_{1} - {p}_{3} ) + β ( {p}_{2} - {p}_{3} ) \\ = ( {N}^{*} {p}_{3} + α * N * ( {p}_{1} - {p}_{3} ) + β * N * ( {p}_{2} - {p}_{3} ) ) / N \\ \approx ( {p}_{3} << n ) + α * ( {p}_{1} - {p}_{3} ) + b * ( {p}_{2} - {p}_{3} ) ) >> n$$

where “<<” and “>>” refer to the C/C++ operators for bit shifting left and right, respectively. Based on this result, the above view interpolation expressions for the dual-image case can be rewritten as

(x,y)=((u₃<<n)+α*(u₁−u₃)+b*(u₂−u₃))>>n,(v₃<<n)+α*(v₁−v₃)+b*(v₂−v₃))>>n)

d=(c₃<<n)+α*(c₁−c₃)+b*(c₂−c₃))>>n

In these embodiments, floating point multiplication is reduced to fast bit shift operations, and all computations are computed in integer math. The actual computed quantities are approximations to the actual values due to round-off errors.

In some embodiments, additional computational speed ups may be obtained by using look up tables. For example, with respect to area-based view interpolation, a finite number of locations in the interface polygon may be identified and these locations may be mapped to specific weighting information. In some embodiments, the interface polygon may be subdivided into many different regions and the same weights may be assigned to each region.

C. Occlusions and Depth Ordering

In some of the above-described view interpolation embodiments, only the points that are visible in all the cameras and the projector are included in view interpolation rendering. Accordingly, there should be at most one scene point mapped to every pixel in the target image and depth ordering and visibility issues are not of concern with respect to these embodiments. However, the resulting view interpolation results may look rather sparse.

In some embodiments, sparseness may be reduced by using a propagation algorithm that extends the view interpolation results. As explained above, the light map data structure tracks the contributions from every camera. Regions between any camera's space and the projection plane that are occluded correspond to holes in the light map. Occlusions are easily identified by simply warping the information from all cameras to the desired view and detecting when multiple points map to the same pixels. In some embodiments, contributions from one or more anchor views that contain information for these occluded regions may be used to estimate values for the occluded regions. In these embodiments, for a given camera, holes in the light map are identified and possible contributions from other cameras are identified. In some embodiments, the holes are filled in by taking a combination (e.g., the mean or median) of the color information obtained from the other anchor views. In some embodiments, the coordinate information for occluded regions in a given anchor view may be interpolated from neighboring points from the given anchor view. In other embodiments, the coordinate information for occluded regions is predicted based on the interface polygon and the computed scaling weights. The hole filling approaches of these embodiments may be performed over all holes in all the anchor views to come up with a dense light map, which may be used to produce much denser view interpolation results. In these embodiments, the synthesized views consist of the union, rather than the intersection, of the information from all anchor views

In the synthetic image, it is possible to have multiple scene points mapping to the same image pixel because of occlusion. This is especially true if the view interpolation results have been extended to fill in the holes. In some embodiments, when multiple points map to the same pixel in the synthetic view, the point that is actually visible in the target image is identified as follows. In some of these embodiments, a preprocessing step is used to calibrate the system. In these embodiments, correspondence information is converted into depth information through triangulation, and the multiple points are prioritized and ordered according to depth. In other embodiments, weak (or partial) calibration (i.e. obtain only the epipolar geometry or an inherent geometric relationship among the cameras pair-wise at a time) together with known ordering techniques are used to identify the visible pixel. For example, the order in which the pixels are rendered is rearranged based on the epipolar geometry, and specifically, on the epipoles (i.e., the projection of one camera's center of projection onto an opposite camera's capture plane). In some embodiments, pixel data is referenced with respect to the projector's coordinate system, independent of the number of cameras. In these embodiments, depth ordering is preserved without having to know any 3-D quantities simply by reorganizing the order that the points are rendered to the target synthetic image.

IV. Camera Calibration

In many applications, it is often necessary to perform some sort of calibration on the imaging equipment to account for differences from a mathematical camera model and to determine an accurate relationship among the coordinate systems of all the imaging devices. The former emphasizes camera parameters, known as the intrinsic parameters, such as focal length, aspect ratio of the individual sensors, the skew of the capture plane and radial lens distortion. The latter, known as the extrinsic parameters, refer to the relative position and orientation of the different imaging devices.

Referring to FIG. 19, in some embodiments, the cameras an imaging system corresponding to one or more of the above-described LUMA embodiments are calibrated as follows. A sequence of patterns of light symbols that temporally encode two-dimensional position information in a projection plane with unique light symbol sequence codes is projected onto a scene (step 116). Patterns reflected from the scene are captured at one or more capture planes of one or more respective image sensors (or cameras) (step 117). A correspondence mapping between the capture planes and the projection plane are computed based at least in part on correspondence between light symbol sequence codes captured at the capture planes and the light symbol sequence codes projected from the projection plane (step 118). Calibration parameters for each image sensor are computed based at least in part on the computed correspondence mappings (step 119). In some embodiments, the dense set of corresponding points found in the reference coordinate system and one or more image sensors is fed into a traditional nonlinear estimator to solve for various camera parameters. The calibration process can be a separate preprocessing step before a 3-D scene/object is captured. Alternatively, the system may automatically calibrate at the same time of the scene capture. Because this approach produces a correspondence mapping for a large number of points, the overall calibration error is reduced. The active projection framework also scales with each additional camera. In these embodiments, image sensor parameters are determined up to a global scale factor.

In embodiments in which calibration is computed as a separate preprocessing step before a 3-D scene/object is captured, a rigid, non-dark (e.g., uniformly white, checkerboard-patterned, or arbitrarily colored) planar reference surface (e.g., projection screen, whiteboard, blank piece of paper) is positioned to receive projected light. In some embodiments, the reference surface covers most, if not all, of the visible projection plane. The system then automatically establishes the correspondence mapping for a dense set of points on the planar surface. World coordinates are assigned for these points. For example, in some embodiments, it may be assumed that the points fall on a rectangular grid defined in local coordinates with the same dimensions and aspect ratio as the projector's coordinate system and that the plane lies in the z=1 plane. Only the points on the planar surface that are visible in all the cameras are used for calibration; the other points are automatically discarded. The correspondence information and the world coordinates are then fed into a nonlinear optimizer to obtain the calibration parameters for the cameras. The resulting camera parameters define the captured image quantities as 3-D coordinates with respect to the plane at z=1. After calibration, the surface is replaced by the object of interest for 3-D shape recovery.

In embodiments in which cameras are automatically calibrated at the same time as scene capture, it is assumed that one or more objects of interest are positioned between the projector and a large planar background. The calibration parameters are determined from the same data set as the object image data. The dense correspondences are established automatically as described above. These correspondences are clustered and modeled to identify the points that correspond to the planar background. This step may be accomplished by Gaussian mixture models or by a 3×3 homography to model the planar background, where outliers are iteratively discarded until the model substantially converges. These points are extracted and assigned their world coordinates as described above, and a nonlinear optimization is performed to compute the calibration parameters. Points (so-called outliers) corresponding to the object of interest, may be used in the 3-D shape recovery algorithms described below.

In some embodiments, the accuracy of the 3-D results may be improved further by back-projecting the points on the 3-D planar surface into the 3-D coordinate system and comparing the back-projected points with the corresponding specified world coordinates. The calibration parameters may be iteratively improved until the results converge.

In some embodiments, there are projection distortions (e.g., nonlinear lens or illumination distortions). In these embodiments, projection distortion parameters are computed during the calibration process. These projection distortion parameters account for differences from a mathematical projector model, including intrinsic parameters, such as focal length, aspect ratio of the projected elements, skew in the projection plane, and radial lens distortion. These parameters may be computed using the same camera calibration process described above in connection with FIG. 19.

V. Three-Dimensional Shape Recovery

In some embodiments, calibration parameters are used to convert the correspondence mapping into 3-D information. Given at least two corresponding image pixels referring to the same scene point, the local 3-D coordinates for the associated scene point are computed using triangulation. For example, assume that the scene point P=(X,Y,Z)^{T} is defined with respect to some world origin. Let p₁=(u₁,v₁,1)^{T} and p₂=(u₂,v₂,1)^{T} be the corresponding image pixels in the first and second images, respectively, defined in homogeneous coordinates. Suppose the 3×3 matrices A₁ and A₂ define the intrinsic parameters of the two cameras; without loss of generality, it is assumed that nonlinear lens distortion is negligible to simplify the computation below. Define (R₁,T₁) and (R₂,T₂) as the 3-D rotation and translation relating the world origin to the first and second cameras, respectively. These transformations correspond to the extrinsic parameters that are obtained through calibration. Then,

Z₁p₁=A₁(R₁P+T₁)

Z₂p₂=A₂(R₂P+T₂)

where Z₁ and Z₂ are the relative depths defined locally with respect to the first and second cameras, respectively. Combining these two expressions, the following projective expression relating the two image pixels is obtained directly:

Z₂p₂=Z₁(A₂R₂R₁⁻¹A₁⁻¹)p₁+A₂(T₂−R₂R₁⁻¹T₁)=Z₁Mp₁+b

Suppose M=[mᵢⱼ] and b=[bⱼ]. Then, the projective scale factor Z₂ to is eliminated to obtain:

u₂=((m₁₁u₁+m₁₂v₁+m₁₃)Z₁+b₁)/((m₃₁u₁+m₃₂v₁+m₃₃)Z₁+b₃)

v₂=((m₂₁u₁+m₂₂v₁+m₂₃)Z₁+b₂)/((m₃₁u₁+m₃₂v₁+m₃₃)Z₁+b₃)

These expressions define the image pixel (u₂,V₂) in the second image as a nonlinear function of the image pixel (u₁,v₁) in the first image and the calibration information. With calibration and correspondence information, the only unknown is the depth Z₁ relative to the first camera, and the above expressions are linear with respect to this unknown. In some embodiments, the above expression may be rewritten and the depth may be computed using known least squares computing techniques. A similar least squares approach may be used to compute for depth in the case where there are more than two corresponding image pixels.

The above-described triangulation process is applied to every set of two or more corresponding image pixels. The resulting depth values may be redefined with respect to any reference coordinate system (e.g., the world origin or any camera in the system). To obtain the 3-D coordinates of a triangulated point with respect to the first camera, the perspective imaging expression is inverted as follows:

P=(X,Y,Z)^{T}=Z₁A₁⁻¹p₁

On the other hand, to obtain the 3-D coordinates with respect to the world origin, the 3-D transformation is inverted as follows:

P=(X,Y,Z)^{T}=R₁¹(Z₁A₁⁻¹p₁−T₁)

The result is a cloud of 3-D points that are defined with respect to the same reference origin corresponding to all scene points visible in at least two cameras.

In some embodiments, some higher structure is imposed on the cloud of points. Traditional triangular or quadrilateral tessellations may be used to generate a model from the point cloud. In some embodiments, the rectangular topology of the reference camera's coordinate system is used for building a 3-D mesh. In these embodiments, two triangular patches in the mesh are used for every four neighboring pixels, along with their related 3-D coordinates, in the reference coordinate system. To avoid incorrectly linking disjoint surfaces in the scene, patches that transcend large depth boundaries are not considered.

The color of each patch comes immediately from the appropriate camera view nearest to the reference coordinate system. The average of the vertices' colors may also be used. A possible extension assigns multiple colors with each patch. This extension would allow for view-dependent texture mapping effects depending on the orientation of the model.

The 3-D meshes may be stitched together to form a complete 3-D model. The multiple meshes may be obtained by capturing a fixed scene with different imaging geometry or else by moving the scene relative to a fixed imaging geometry. An example of the latter is an object of interest captured as it rotates on a turntable as described in the next section. In some embodiments, the results from each mesh are back-projected to a common coordinate system, and overlapping patches are fused and stitched together using known image processing techniques.

VI. Turntable-Based Embodiments

A. Three-Dimensional Shape Recovery

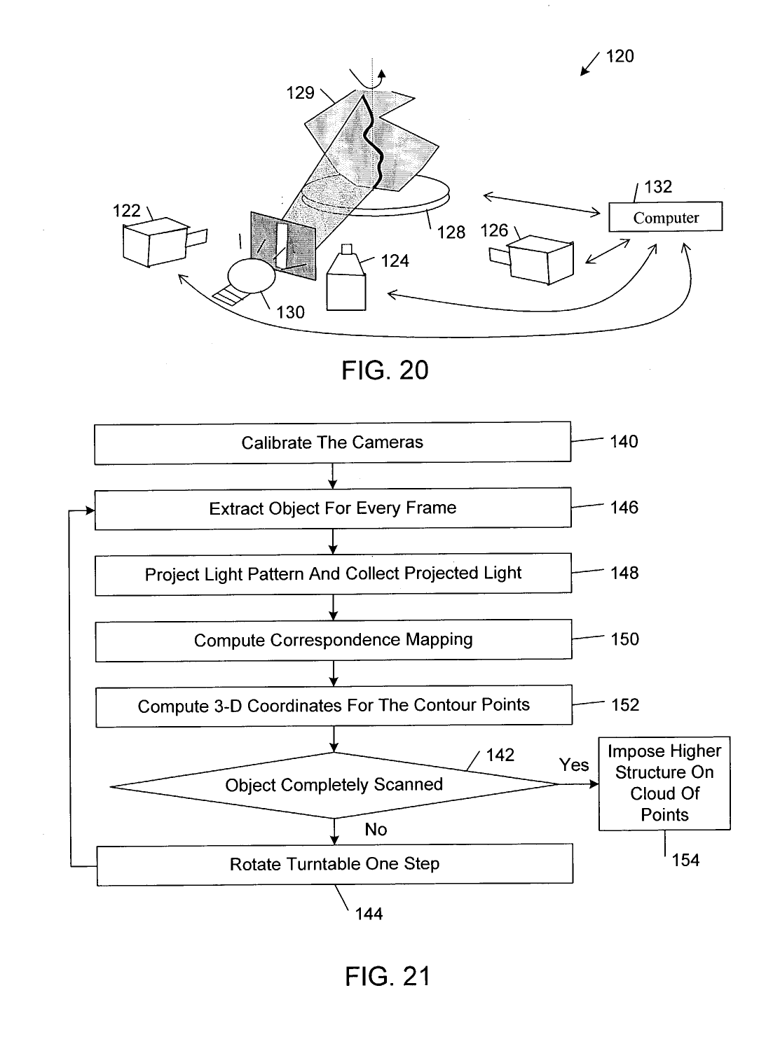

Referring to FIG. 20, in some embodiments, a multiframe correspondence system 120 includes multiple stationary computer-controlled imaging devices 122, 124, 126 (e.g., digital cameras or video cameras), a computer-controlled turntable 128 on which to place the object 129 of interest, a fixed lighting source 130 (e.g. strong colored incandescent light projector with vertical slit filter, laser beam apparatus with vertical diffraction, light projector) that is controlled by a computer 132. The cameras 122-126 are placed relatively close to one another and oriented toward the turntable 128 so that the object 129 is visible. The light source 130 projects a series of light patterns from the source. The projected light is easily detected on the object. In the illustrated embodiment, the actual location of the light source 130 need not be estimated.

Referring to FIG. 21, in some embodiments, the embodiments of FIG. 20 may be operated as follows to compute 3-D structure. For the purpose of the following description, it is assumed that there are only two cameras; the general case is a straightforward extension. It is also assumed that one of the camera viewpoints is selected as the reference frame. Let T be the number of steps per revolution for the turntable.

1. Calibrate the cameras (step 140). Standard calibration techniques may be used to determine the relative orientation, and hence the epipolar geometry, between the cameras from a known test pattern. The location of the turntable center is estimated by projecting the center to the two views and triangulating the imaged points.

2. For every step j=1:T (steps 142, 144),

a. Perform object extraction for every frame (step 146). This is an optional step but may lead to more reliable 3-D estimation. The turntable is first filmed without the object to build up statistics on the background. For better performance, a uniform colored background may be added. Then, at every step and for both views, the object is identified as the points that differ significantly from the background statistics.

b. Project and capture light patterns in both views (step 148) and compute a correspondence mapping (step 150). Any of the above-described coded light pattern embodiments may be used in this step.

c. Compute 3-D coordinates for the contour points (step 152). With the estimated relative orientation of the cameras, this computation is straightforward by triangulation of the corresponding points. The color for the corresponding scene point comes from the multiple views and may be used for view dependent texture mapping.

3. Impose some higher structure on the resulting cloud of points (step 154). Traditional triangular tessellations may be used to generate a model of the object. Note that the center and rotational angle of the turntable are important in order to form a complete and consistent model; the center's location is obtained above and the angle is simply computed from the number of steps per revolution. The 3-D model may be formed by formulating the model directly or by stitching together partial mesh estimates together.

In some implementations, the quality of the scan will depend on the accuracy of the calibration step, the ability to discriminate the projected light on the object, and the reflectance properties of the scanned object.

B. View Interpolation

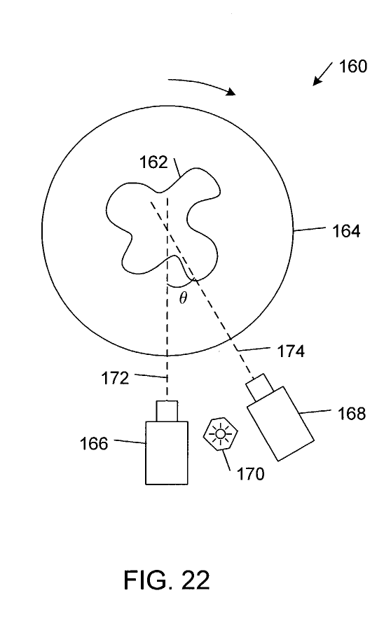

Referring to FIG. 22, in some embodiments, a multiframe imaging system 160 may be used to rapidly capture images of an object 162 that is supported on a turntable 164. These images (or anchor views) may be used for view interpolation. Imaging system 160 includes a pair of cameras 166, 168 and a projector 170. Cameras 166, 168 are separated by an angle θ with respect to turntable 164 and placed at fixed locations away from the turntable 164. In some implementations, θ is selected to divide evenly into 360°. In the illustrated embodiment, the optical axes of cameras 166, 168 intersect the center of the turntable 164 and the orientation of cameras 166, 168 are the same relative to the turntable surface so that the object will appear to be rotating properly about the turntable's axis of rotation in the synthesized views. That is, the cameras are positioned so that the rotation of the object 162 on turntable 164 is equivalent to rotating the positions of the cameras with respect to the center of the turntable 164. Projector 170 may be positioned at any location that allows both cameras 166, 168 to capture the light patterns projected from the projector 170.

In operation, object 162 is placed on turntable 164 and is rotated 0 degrees N times, where N=360/θ. For each turntable position, cameras 166, 168 capture respective anchor views containing color information of the object 162 under normal lighting conditions. Implicit shape information also is captured through active projection of the coded LUMA light patterns, as described above. Dense correspondence mappings between cameras 166, 168 are computed for each turntable positions using the LUMA methods described above. In the illustrated embodiment, the viewpoint of the object from the second camera at time t is the same as that from the first camera at time t+1. This ensures that there will be a smooth transition when interpolating views. That is, the cameras 166, 168 are positioned around the turntable such that the view of the object of camera 166 is the same as that at camera 168 but at a different time period. For example, suppose the fixed cameras are positioned at 0° and 45° and their optical axes 172, 174 intersect the center of the turntable 164. Dense correspondences between the two cameras 166, 168 are captured, allowing views to be interpolated (without estimating 3-D information) between cameras 166, 168. The turntable 164 and object 162 are rotated 45° in a clockwise direction until the view originally seen at 0° by camera 168 lines up with view of camera 166. Images are captured by camera 166, 168 and the dense correspondences between the two cameras 166, 168 are again computed. At this point, the views between the effective −45° and 0° may be interpolated. The process is repeated six more times, for a total of eight turntable positions. In the end, eight sets of pairwise correspondences are computed where the end point of one set is the starting point of the next set. In this way, synthetic images to simulate object rotation around the entire object 162 may be computed.

To synthesize an arbitrary angle from this representation, a user may specify a desired viewing angle between 0° and 360°. If the angle corresponds to one of the N anchor views, then the color information corresponding to the anchor view is displayed. Otherwise, the two anchor views closest in angle are selected and the desired view is generated by interpolating the information contained in the two selected anchor views. In particular, every point that is visible in the two anchor views is identified. The spatial and color information in the identified visible points then are interpolated. For example, suppose a point in the 3-D scene projects to the image pixel (u,v) with generalized color vector c in the first anchor view and to the image pixel (u′,v′) with color c′ in the second anchor view. Then, the same scene point projects to the image pixel (x,y) with color d in the desired synthetic view of parameter α given by:

(x,y)=((1−α)*u+α*u′,(1−α)*v+α*v′)=(u+α*(u−u′),v+α*(v−v′))

d=(1−α)*c+α*c′=c+α*(c−c′)

where α corresponds to the angle between the first anchor view and the desired viewpoint.

In the embodiment of FIG. 22, two cameras 166, 168 are used to capture images of object 162, which then may be used for view interpolation between the two cameras 166, 168. In other embodiments, a single camera may be used to capture images, which then may be used for view interpolation between the camera and the projector plane, as described above.

Other embodiments are within the scope of the claims.

The systems and methods described herein are not limited to any particular hardware or software configuration, but rather they may be implemented in any computing or processing environment, including in digital electronic circuitry or in computer hardware, firmware, or software.

What is claimed is:

1. A method of multiframe image processing, comprising:
computing correspondence mappings from one or more anchor views of a scene to a common reference anchor view; and
interpolating between anchor views based on the computed correspondence mappings to generate a synthetic view of the scene.

2. The method of claim 1, wherein computing correspondence mappings comprises:
projecting onto the scene a sequence of patterns of light symbols that temporally encode two-dimensional position information in the reference anchor view with unique light code symbols;
capturing light patterns reflected from the scene at one or more anchor views; and
computing a correspondence mapping between the reference anchor view and the one or more other anchor views based at least in part on correspondence between light symbol sequence codes captured at the one or more anchor views and light symbol sequence codes projected from the reference anchor view.

3. The method of claim 1, further comprising storing the computed correspondence mappings in a data structure including an array of points defined in a reference anchor view space and linked to respective lists of corresponding points in the one or more other anchor views.

4. The method of claim 1, wherein the synthetic view is generated by interpolating between the reference anchor view and at least one other anchor view.

5. The method of claim 1, wherein the synthetic view is generated by interpolating between anchor views in N dimensions, wherein N is an integer greater than 0.

6. The method of claim 5, wherein interpolating between anchor views comprises parameterizing an N-dimensional space of synthesizable views, and weighting contributions from anchor views being interpolated to the synthetic view based at least in part on relative proximity of the synthetic view to the anchor views being interpolated.

7. The method of claim 6, wherein the synthetic view is generated by interpolating between anchor views with contributions to the synthetic view weighted in accordance with Barycentric coordinates of the synthetic view defined relative to the anchor views being interpolated.

8. The method of claim 6, wherein the N-dimensional space of synthesizable views is parameterized discretely.

9. The method of claim 1, wherein the synthetic view is generated based on points visible in all anchor views being interpolated.

10. The method of claim 1, further comprising identifying in a given anchor view one or more regions occluded from visualizing the scene.

11. The method of claim 10, further comprising computing color information for occluded regions of the given anchor view based on color information in corresponding regions of at least one other anchor view.

12. The method of claim 10, further comprising computing coordinate information for occluded regions of the given anchor view by interpolating between neighboring non-occluded regions of the given anchor view.

13. The method of claim 1, further comprising ordering multiple points of the scene mapping to a common point in the synthetic view.

14. The method of claim 1, further comprising rotating an object in the scene about an axis.

15. A method of multiframe image processing, comprising:
computing correspondence mappings between one or more pairs of anchor views of a scene;
parameterizing a discretized space of synthesizable views referenced to the anchor views of the scene; and
interpolating between anchor views in the parameterized discretized space based on the computed correspondence mappings to generate a synthetic view of the scene.

16. The method of claim 15, wherein the discretized space of synthesizable views is parameterized in N dimensions and the synthetic view is generated by interpolating between anchor views in N dimensions, wherein N is an integer greater than 0.

17. The method of claim 15, wherein contributions from anchor views being interpolated to the synthetic view are weighted based at least in part on relative proximity of the synthetic view to the anchor views being interpolated.

18. The method of claim 15, wherein the synthetic view is generated by interpolating between anchor views with contributions to the synthetic view weighted in accordance with Barycentric coordinates of the synthetic view defined relative to the anchor views being interpolated.

19. A method of multiframe image processing, comprising:
computing correspondence mappings between one or more pairs of anchor views of a scene;
identifying in a given anchor view one or more regions occluded from visualizing the scene; and
computing color information for occluded regions of the given anchor view based on color information in corresponding regions of at least one other anchor view.

20. The method of claim 19, further comprising computing coordinate information for occluded regions of the given anchor view by interpolating between neighboring non-occluded regions of the given anchor view.

21. A method of multiframe image processing, comprising:
computing correspondence mappings between two or more pairs of anchor views of a scene;
presenting to a user a graphical user interface comprising an N-dimensional space of synthesizable views parameterized based on the computed correspondence mappings and comprising an interface shape representing relative locations of the anchor views, wherein N is an integer greater than 0; and
generating a synthetic view of the scene by interpolating between anchor views based on the computed correspondence mappings with anchor view contributions to the synthetic view weighted based on a location in the graphical user interface selected by the user.

22. The method of claim 21, wherein vertices of the interface shape are computed based on correspondence differences computed for successive anchor view pairs in an ordered sequence of anchor views.

23. The method of claim 22, wherein vertices of the interface shape correspond to medians of correspondence coordinate differences.

24. The method of claim 21, wherein further comprising identifying a set of three vertices of the interface shape defining an interface triangle closest to the user selected location in the graphical user interface.

25. The method of claim 24, wherein the user selected location is circumscribed by the interface triangle.

26. The method of claim 24, wherein the user selected location is outside the interface triangle.

27. The method of claim 24, wherein the user selected location is along a boundary of the interface triangle.

28. The method of claim 24, wherein contributions of anchor views to the synthetic view are weighted in accordance with Barycentric coordinates of the user selected location defined relative to the vertices of the interface triangle.

29. The method of claim 24, wherein vertices of the interface triangle correspond to respective anchor views of the scene.

30. A method of multiframe image processing, comprising:
projecting onto a scene a sequence of patterns of light symbols that temporally encode two-dimensional position information in a projection plane with unique light symbol sequence codes;
capturing light patterns reflected from the scene at a capture plane of an image sensor;
computing a correspondence mapping between the capture plane and the projection plane based at least in part on correspondence between light symbol sequence codes captured at the capture plane and light symbol sequence codes projected from the projection plane; and
computing calibration parameters for the image sensors based at least in part on the computed correspondence mapping.

31. The method of claim 30, wherein computing calibration parameters comprises computing intrinsic image sensor parameters.

32. The method of claim 31, wherein computing intrinsic image sensor parameters comprises computing focal length, aspect ratio, skew, and radial lens distortion parameters for the image sensor.

33. The method of claim 30, wherein computing calibration parameters comprises computing extrinsic image sensor parameters.

34. The method of claim 33, wherein computing extrinsic image sensor parameters comprises computing relative position and orientation parameters for the image sensors with respect to some common reference coordinate system.

35. The method of claim 30, further comprising computing calibration parameters for a light source projecting the light symbol patterns.

36. The method of claim 35, wherein computing light source calibration parameters comprises computing focal length, aspect ratio, skew, and radial lens distortion parameters for the projector.

37. The method of claim 30, wherein calibration parameters are computed based at least in part on a correspondence mapping computed for a known scene.

38. The method of claim 37, wherein the known scene has a blank planar surface oriented to receive the projected sequence of light patterns.

39. The method of claim 38, wherein the blank planar surface is colored with a uniform non-dark color.

40. The method of claim 37, wherein the known scene includes an object of interest positioned between the projection plane and the planar surface.

41. The method of claim 40, wherein computing calibration parameters comprises identifying regions in the capture plane corresponding to regions of the planar surface.

42. The method of claim 30, wherein among the projected light symbol patterns are light patterns respectively comprising different spatial variations of light in the projection plane.

43. The method of claim 42, wherein each light symbol pattern comprises a binary pattern of light and dark rectangular stripe symbols.

44. The method of claim 43, wherein each light symbol pattern includes light and dark stripe symbols of substantially equal size in the projection plane, and light and dark stripe symbols of different light symbol patterns are of substantially different size in the projection plane.

45. The method of claim 43, wherein a first subset of light symbol patterns encodes rows of a reference grid in the projection plane, and a second subset of light symbol patterns encodes columns of the reference grid in the projection plane.

46. The method of claim 42, wherein each light pattern comprises a multicolor pattern of light.

47. The method of claim 30, further comprising storing the computed correspondence mapping in a data structure including an array of points defined in the projection plane and linked to respective corresponding points in the capture plane.

48. The method of claim 30, further comprising capturing patterns reflected from the scene at one or more additional capture planes of one or more respective image sensors, and computing a correspondence mapping between each capture plane and the projection plane based at least in part on correspondence between light symbol sequence codes captured at each capture plane and light symbol sequence codes projected from the projection plane.

49. The method of claim 30, further comprising computing a three-dimensional coordinate system based on the computed calibration parameters and the computed correspondence mapping.

50. The method of claim 49, wherein computing calibration parameters comprises assigning real world coordinates for points in the scene.

51. The method of claim 50, further comprising back-projecting points in the scene into the computed three-dimensional coordinate system, and modifying the assigned world coordinates based at least in part on a comparison between the back-projected points and the assigned world coordinates.

52. A system for multiframe image processing, comprising:
a light source operable to project onto a scene a sequence of patterns of light symbols that temporally encode two-dimensional position information in a projection plane with unique light symbol sequence codes;
at least one imaging device operable to capture light patterns reflected from the scene at a respective capture plane;
processing system operable to compute a correspondence mapping between the capture plane and the projection plane based at least in part on correspondence between light symbol sequence codes captured at the capture plane and light symbol sequence codes projected from the projection plane, and to compute calibration parameters for the image sensor based at least in part on the computed correspondence mapping.

53. The system of claim 52, further comprising a turntable operable to rotate an object in the scene about an axis.

54. A method of multiframe image processing, comprising:
(a) projecting onto an object a sequence of patterns of light symbols that temporally encode two-dimensional position information in a projection plane with unique light symbol sequence codes;
(b) capturing light patterns reflected from the object at a pair of capture planes with optical axes separated by an angle θ;
(c) computing a correspondence mapping between the pair of capture planes based at least in part on correspondence between light symbol sequence codes captured at the capture planes and light symbol sequence codes projected from the projection plane;
(d) rotating the object through an angle θ; and
(e) repeating steps (a)-(d) until the object has been rotated through a prescribed angle.

55. The method of claim 54, further comprising interpolating between pairs of anchor views based on the corresponding computed correspondence mappings to generate one or more synthetic views of the object.
